(19) United States
(12) Patent Application Publication
(10) Pub. No.: US 2026/0338699 A1
(43) Pub. Date: Oct. 29, 2026

(54) BIOLAYER INTERFEROMETRY SENSOR WITH FACETED OPTICAL FIBER AND APPARATUS FOR USING THE SAME

(71) Applicant: Sartorius BioAnalytical Instruments, Inc., Bohemia, NY (US)

(72) Inventors: Yuri Krasov, Bohemia, NY (US); Andrey Klishin, Bohemia, NY (US)

(73) Assignee: Sartorius BioAnalytical Instruments, Inc., Bohemia, NY (US)

(21) Appl. No.: 19/110,305

(22) PCT Filed: Aug. 31, 2023
(86) PCT No.: PCT/IB2023/058638

§ 371 Date: Mar. 10, 2025

Related U.S. Application Data
(60) Provisional application No. 63/404,620, filed on Sep. 8, 2022.

(51) Int. Cl. G01N 21/77

(52) U.S. Cl. CPC G01N 21/7703; G01N 2021/7773; G01N 2021/7779

(57) ABSTRACT

A biosensor includes an optical fiber that has a proximal end portion and a distal end portion. The proximal end portion is configured to receive light from a light source and is configured to deliver reflected light to a detector. The optical fiber has a polygonal cross-section. The distal end portion is configured to have analytes bind thereto such that light reflected from the distal end portion is phase shifted based on a thickness of analytes bound to the distal end portion.

### CROSS-REFERENCE TO RELATED APPLICATIONS

This application is a national stage application under 35 U.S.C. § 371 of PCT Application No. PCT/IB 2023/058638, filed Aug. 31, 2023, which claims the benefit of, and priority to, U.S. patent application Ser. No. 63/404,620, filed Sep. 8, 2022. The entire contents of each of the above applications are hereby incorporated by reference.

### BACKGROUND

### 1. Technical Field

The present disclosure relates to optical sensors and, more specifically, an optical sensor for interferometry having a faceted optical fiber.

### 2. Discussion of Related Art

Diagnostic tests based on a binding event between members of an analyte-anti-analyte binding pair are widely used in medical, veterinary, agricultural, and research applications. Typically, such methods are employed to detect the presence or amount of an analyte in a sample, and/or the rate of binding of the analyte to the anti-analyte. Typical analyte-anti-analyte pairs include complementary strands of nucleic acids, antigen-antibody pairs, and receptor-receptor binding agent, where the analyte can be either member of the pair, and the anti-analyte molecule, the opposite member.

Diagnostics methods of this type often employ a solid surface having immobilized anti-analyte molecules or materials to which sample analyte molecules will bind specifically and with high affinity at a defined detection zone. In this type of assay, known as a solid-phase assay, the solid surface is exposed to the sample under conditions that promote analyte binding to immobilized anti-analyte molecules. The binding event can be detected directly, e.g., by a change in the mass, reflectivity, thickness, color, or other characteristic indicative of a binding event. Where the analyte is pre-labeled, e.g., with a chromophore, fluorescent, or radiolabel, the binding event is detectable by the presence and/or amount of detectable label at the detection zone. Alternatively, the analyte can be labeled after it is bound at the detection zone, e.g., with a secondary, fluorescent-labeled anti-analyte antibody.

A fiberoptic interferometer assay device can be designed to detect analyte binding to an end surface of an optical fiber of the fiberoptic interferometer assay device. Analyte detection is based on a change in the thickness at the end surface of the optical fiber resulting from the binding of analyte molecules to the surface, with greater amount of analyte producing a greater thickness-related change in the interference signal. The change in interference signal is due to a phase shift between light reflected from internal and external surfaces of an optical resonator layer at the end of the optical fiber where the external interface includes the binding layer.

An interferometer assay device will yield readily observable changes in spectral peak and valley (extrema) positions such that relatively small optical thickness changes at the end surface of the optical fiber can be detected as significant changes in the spectral positions of interference wavelength peaks and valleys.

An interferometer assay device may include a bio-layer interferometer (BLI) sensor that includes the optical fiber with an optical resonator layer at the end of the optical fiber that has an end surface to which an analyte may bind to form a biolayer. The signal to noise ratio of the light reflected from the internal surface of the optical resonator and the external surface of the optical resonator, which comprises the biolayer, may affect the ability of the interferometer assay device to detect small optical thickness changes in the biolayer.

### SUMMARY

This disclosure relates generally to an interferometer assay device with an improved signal to noise ratio. Specifically, this disclosure is directed to a BLI sensor of an interferometer assay device that is designed to improve a signal to noise ratio of light reflected from the optical resonator surfaces of the BLI sensor. The BLI sensors disclosed herein include faceted optical fibers that may improve the spatial distribution of photons at the optical resonator faces of the fiberoptic interferometer such that the signal to noise ratio of light reflected from the end surface of the optical fiber is improved with respect to a non-faceted optical fiber.

In an aspect of the present disclosure, a biosensor includes a faceted optical fiber having a proximal end portion and a distal end portion. The proximal end portion is configured to receive light from a light source and to deliver reflected light to a detector. The faceted optical fiber has a polygonal cross-section. The distal end portion is configured to have analytes bind thereto such that light reflected from the distal end portion is phase shifted based on a thickness of analytes bound to the distal end portion.

In another aspect of the present disclosure, a biosensor includes an optical fiber that has a proximal end portion and a distal end portion. The proximal end portion is configured to receive light form a light source and is configured to deliver reflected light to a detector. The optical fiber has a polygonal cross-section. The distal end portion is configured to have analytes bind thereto such that light reflected from the distal end portion is phase shifted based on a thickness of analytes bound to the distal end portion.

In aspects, the optical fiber has a triangular, square, pentagonal, hexagonal, octagonal, or decagonal cross-section. The optical fiber may be configured to scatter light to evenly distribute light in the distal end portion of the optical fiber. The optical fiber may be configured to receive a beam of light in the proximal end portion and uniformly distribute light from the received beam of light at the distal end portion thereof. The optical fiber may have an improved signal-to-noise ratio compared to an optical fiber having a circular cross-section. The optical fiber may have an increased sensitivity when compared to an optical fiber having a circular cross-section.

In some aspects, the biosensor includes an optical resonator at the distal end portion. The optical resonator may include a first reflective surface and a second reflective surface. The first reflective surface may be configured to reflect light with a first phase and the second reflective surface may be configured to reflect light with a second phase which is phase shifted based on a thickness of analytes bound to the optical resonator.

In particular aspects, the biosensor includes a cladding disposed about the optical fiber, the cladding may form an optical fiber assembly with the optical fiber such that the optical fiber assembly has an optical fiber with a polygonal cross-section disposed within the cladding which has a circular or ovular cross-section at an outside diameter thereof. The optical fiber may be disposed within a passage defined by the cladding.

In another aspect of the present disclosure, a biosensor includes an optical fiber that has a proximal end portion and a distal end portion. The proximal end portion is configured to receive light from a light source and is configured to deliver reflected light to a detector. The distal end portion is configured to have analytes bind thereto such that light reflected form the distal end portion is phase shifted based on a thickness of analytes bound to the distal end portion. The optical fiber has a faceted core that is disposed within a first cladding. The faceted core has a core cross-section.

In aspects, the first cladding defines an exterior cross-section of the optical fiber. The exterior cross-section may be circular or ovular. The core cross-section may be triangular, square, pentagonal, hexagonal, octagonal, or decagonal.

In some aspects, the optical fiber includes a second cladding that is disposed about the first cladding. The second cladding may define an exterior cross-section of a different shape than a shape of the core cross-section. The exterior cross-section may be circular or ovular. The optical fiber may include a coating over the second cladding. The coating may define an exterior surface of the optical fiber.

In certain aspects, the first cladding is formed of glass or quartz. The second cladding may be formed of glass or quartz. The coating may be formed of polyamide or polytetrafluoroethylene. The first cladding and the second cladding may be formed of the same material or formed of different materials. The faceted core and the first cladding in combination with one another may provide a desired numerical aperture of the optical fiber.

In another aspect of the present disclosure, a biosensor includes a faceted optical fiber that has a proximal end portion and a distal end portion. The proximal end portion is configured to receive light from a light source. The faceted optical fiber is configured to scatter the received light such that a distribution of light at the distal end portion of the faceted optical fiber is uniformly distributed. The faceted optical fiber may have an increased signal-to-noise ratio with respect to a non-faceted optical fiber. The faceted optical fiber may include a faceted core that is disposed within a cladding. The cladding may define an exterior surface having a circular or ovular cross-section.

In aspects, the biosensors detailed herein may include an optical fiber or an optical fiber assembly and a hub that is attached to the optical couple 36 with the optical fiber or the optical fiber assembly extending distally from the hub. The hub may space a proximal end of the optical fiber or the optical fiber assembly from a fiber optic bundle providing light from a light source and returning light to a detector.

In another aspect of the present disclosure, an interferometer apparatus includes a first optical waveguide that is configured to receive light from a light source, a second optical waveguide that is configured to deliver reflected light to a detector, an optical coupler spatially separating a distal portion of the first optical waveguide from a distal portion of the second optical waveguide, and a biosensor attached to the optical coupler. The biosensor including an optical fiber as detailed herein.

In aspects, the interferometer apparatus includes a light source that is in optical communication with the first optical waveguide and that is configured to provide light to the first optical waveguide. The light source may be a broad-spectrum light source.

In some aspects, the interferometer apparatus includes a detector that is configured to receive light from the second optical waveguide. The first optical waveguide and the second optical waveguide may both be disposed in a single fiber optic bundle. The fiber optic bundle may be arranged such that the fibers of the first optical waveguide are arranged around a single fiber of the second optical waveguide.

In certain aspects, the biosensor is attached to the optical couple such that a gap is defined between a distal end of the fiber optical bundle and a proximal end of the optical fiber. The gap may be in a range of 25 μm to 600 μm.

In particular aspects, the biosensor may include an optical resonator at a distal end portion of the optical fiber. The optical resonator may include a first reflective surface and a second reflective surface. The first reflective surface may be configured to reflect light with a first phase and the second reflective surface may be configured to reflect light with a second phase which is phase shifted based on a thickness of analytes bound to the optical resonator.

Further, to the extent consistent, any of the embodiments or aspects described herein may be used in conjunction with any or all of the other embodiments or aspects described herein.

### BRIEF DESCRIPTION OF THE DRAWINGS

Various aspects of the present disclosure are described hereinbelow with reference to the drawings, which are incorporated in and constitute a part of this specification, wherein:

FIG. 1 is a schematic view of an interferometer assay apparatus provided in accordance with the present disclosure inserted into a well plate having an analyte;

FIG. 2 is an end perspective view of an optical coupler of the interferometer assay apparatus of FIG. 1 illustrating a fiber optic bundle of the apparatus;

FIG. 3 is a partial perspective view of the apparatus of FIG. 1 with a BLI sensor separated from the optical coupler;

FIG. 4 is a partial, longitudinal cross-sectional view of the optical coupler and BLI sensor of FIG. 3 with the BLI sensor attached to the optical coupler;

FIG. 5 is an enlarged view of a portion of the optical coupler and BLI sensor of FIG. 4;

FIG. 6 is a schematic view of the interface between the fiber optic bundle and an optical fiber of the apparatus of FIG. 1;

FIG. 7 is a beam profile of a first optical waveguide of the fiber optic bundle of FIG. 2;

FIG. 8 is a beam profile at a distal end portion of the BLI sensor of FIG. 2;

FIG. 9 is a graphical representation of the beam profile at the distal end portion of the BLI sensor of FIG. 8;

FIG. 10 is a perspective view of a faceted BLI sensor provided in accordance with the present disclosure;

FIG. 11 is a beam profile at a distal end portion of the faceted BLI sensor of FIG. 9;

FIG. 12 is a graphical representation of the beam profile at the distal end portion of the BLI sensor of FIG. 11;

FIG. 13 is a beam profile at a distal end portion of another faceted BLI sensor provided in accordance with an embodiment of the present disclosure;

FIG. 14 is a graphical representation of the beam profile at the distal end portion of the BLI sensor of FIG. 13;

FIG. 15 is a perspective view of a BLI sensor provided in accordance with an embodiment of the present disclosure including an optical fiber having a triangular cross-section;

FIG. 16 is a perspective view of a BLI sensor provided in accordance with an embodiment of the present disclosure including an optical fiber having a square cross-section;

FIG. 17 is a perspective view of a BLI sensor provided in accordance with an embodiment of the present disclosure including an optical fiber having a pentagonal cross-section;

FIG. 18 is a perspective view of a BLI sensor provided in accordance with an embodiment of the present disclosure including an optical fiber having an octagonal cross-section;

FIG. 19 is a perspective view of a BLI sensor provided in accordance with an embodiment of the present disclosure including an optical fiber having a decagonal cross-section.

FIG. 20 is a perspective view of a BLI sensor provided in accordance with an embodiment of the present disclosure including an optical fiber having a circular cross-section with an internal hexagonal optical fiber;

FIG. 21 is an enlarged view of the tip of the BLI sensor of FIG. 20;

FIG. 22 is a view of a tip of an internally faceted optical fiber of another BLI sensor provided in accordance with an embodiment of the present disclosure having a circular cross-section with an internal hexagonal core; and

FIG. 23 is a view of a tip of an internally faceted optical fiber of a BLI sensor provided in accordance with an embodiment of the present disclosure having an ovular cross-section with an internal octagonal core.

### DETAILED DESCRIPTION

The present disclosure will now be described more fully hereinafter with reference to example embodiments thereof with reference to the drawings in which like reference numerals designate identical or corresponding elements in each of the several views. These example embodiments are described so that this disclosure will be thorough and complete, and will fully convey the scope of the disclosure to those skilled in the art. Features from one embodiment or aspect can be combined with features from any other embodiment or aspect in any appropriate combination. For example, any individual or collective features of method aspects or embodiments can be applied to apparatus, product, or component aspects or embodiments and vice versa. The disclosure may be embodied in many different forms and should not be construed as limited to the embodiments set forth herein; rather, these embodiments are provided so that this disclosure will satisfy applicable legal requirements. As used in the specification and the appended claims, the singular forms “a,” “an,” “the,” and the like include plural referents unless the context clearly dictates otherwise. In addition, while reference may be made herein to quantitative measures, values, geometric relationships or the like, unless otherwise stated, any one or more if not all of these may be absolute or approximate to account for acceptable variations that may occur, such as those due to manufacturing or engineering tolerances or the like.

As used herein, the term “proximal” refers to the portion of the device or component thereof that is closer to the user or machine using the device and the term “distal” refers to the portion of the device or component thereof that is farther from the user or machine using the device.

An “analyte-binding” molecule or material refers to any molecule or material capable of participating in a specific binding reaction with an analyte molecule. Examples include, but are not limited to, antibody-antigen binding reactions and nucleic acid hybridization reactions.

A “specific binding reaction” refers to a binding reaction that is saturable, usually reversible, and that can be completed with an excess of one of the reactants. Specific binding reactions are characterized by complementarity of shape, charge, and other binding determinants between the participants in the specific binding reaction.

An “antibody” refers to an immunoglobulin molecule having two heavy chains and two light chains prepared by any method known in the art or later developed and includes polyclonal antibodies such as those produced by inoculating a mammal such as a goat, mouse, rabbit, etc. with an immunogen, as well as monoclonal antibodies produced using the well-known Kohler Milstein hybridoma fusion technique. The term includes antibodies produced using genetic engineering methods such as those employing, e.g., SCID mice reconstituted with human immunoglobulin genes, as well as antibodies that have been humanized using art-known resurfacing techniques.

An “antibody fragment” refers to a fragment of an antibody molecule produced by chemical cleavage or genetic engineering techniques, as well as to single chain variable fragments (SCFvs) such as those produced using combinatorial genetic libraries and phage display technologies. Antibody fragments used in accordance with the present invention usually retain the ability to bind their cognate antigen and so include variable sequences and antigen combining sites.

A “biolayer” refers to an analyte-binding molecule or material with or without bound analyte.

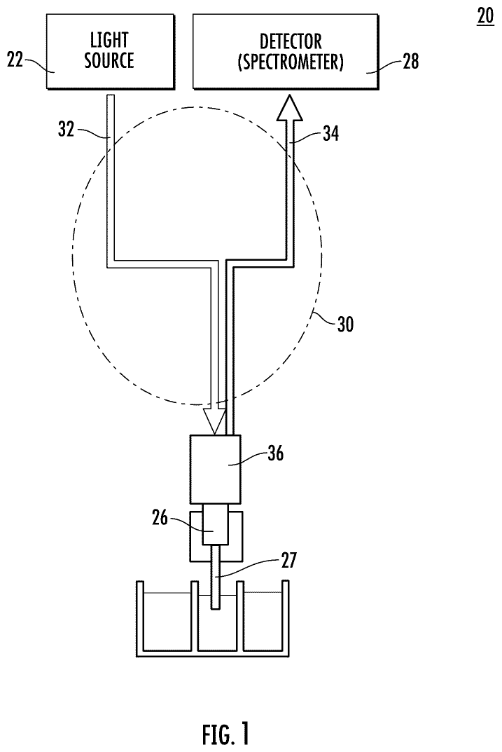

Referring now to FIG. 1, an interferometer assay apparatus 20 is provided in accordance with the present disclosure. The apparatus 20 includes a light source 22, an optical assembly 26, and a detector unit 28. The bio-layer interferometer (BLI) sensor or optical assembly 26 functions as a sensing element or detector tip to detect analytes attached to an end thereof as described in greater detail below. The detector unit 28 detects interference signals produced by interfering light waves reflected from the optical assembly 26.

The light source 22 directs light into the optical assembly 26 which is reflected back to the detector unit 28 through an optical coupling assembly indicated by dashed lines at 30. The coupling assembly 30 includes a first optical waveguide or fiber 32 that extends from the light source 22 to the optical assembly 26, a second optical waveguide or fiber 34 which carries reflected light from the optical assembly 26 to the detector 28, and an optical coupler 36 which optically couples the first optical waveguide 32 and the second optical waveguide 34. In some embodiments, the coupling assembly 36 includes a lens system constructed to focus a light beam on an upper surface of the optical assembly 26 and to direct reflected interfering light from the optical assembly 26 to the detector 28.

The light source 22 can be a white light source, such as a light emitting diode (LED), that produces light over a broad spectrum, e.g., 400 nm or less to 700 nm or greater, typically over a spectral range of at least 100 nm. In some embodiments, the light source 22 can be a plurality of sources each having a different characteristic wavelength, such as LEDs designed for light emission at different selected wavelengths in the visible light range. The same function can be achieved by a single light source, e.g., white light source, with suitable filters for directing light with different selected wavelengths onto the optical assembly 26.

The detector 28 may be a spectrometer, such as charge-coupled device (CCD), capable of recording the spectrum of the reflected interfering light from the optical assembly 26. In some embodiments, where the light source 22 operates to direct different selected wavelengths onto the optical assembly 26, the detector 28 may be a simple photodetector for recording light intensity at each of the different irradiating wavelengths. In certain embodiments, the detector 28 may include one or more filters which allows detection of light intensity, e.g., from a white-light source, at each of a plurality of selected wavelengths of the interference reflectance wave.

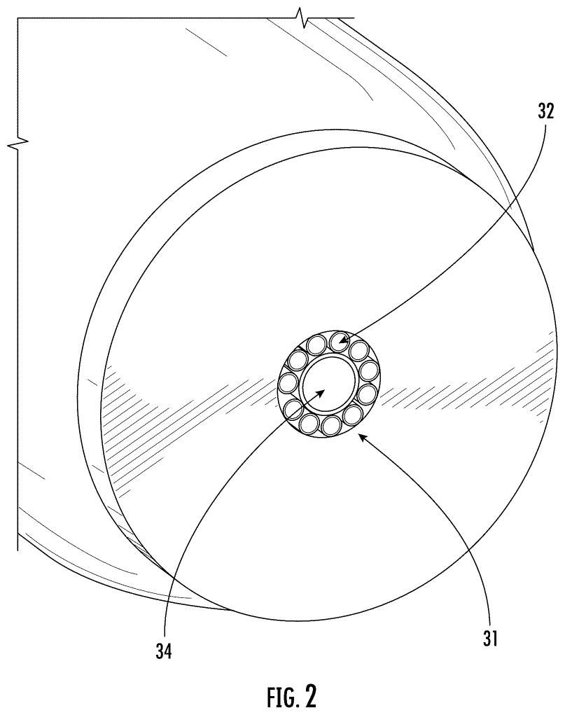

With additional reference to FIG. 2, the first optical waveguide 32 and/or the second optical waveguide 34 may be in the form of a fiber optic bundle (FOB) 31. As shown, the first optical waveguide 32 includes several fiber optic elements surrounding a single fiber optic element of the second optical waveguide 34. This arrangement separates delivery of light from the light source 22 from delivery of the reflected light from the optical assembly 26 to the detector 28. It will be appreciated that other arrangements of the first optical waveguide 32 and the second optical waveguide 34 may allow for spatial separation of the light from the light source 22 and the reflected light from the optical assembly 26. The separation of the light from the light source 22 and the reflected light from the optical assembly 26 may improve a signal to noise ratio (SNR) of the apparatus 20. In some embodiments, the first optical waveguide 32 is a single fiber and the second fiber optical waveguide 34 is formed of a plurality of fibers.

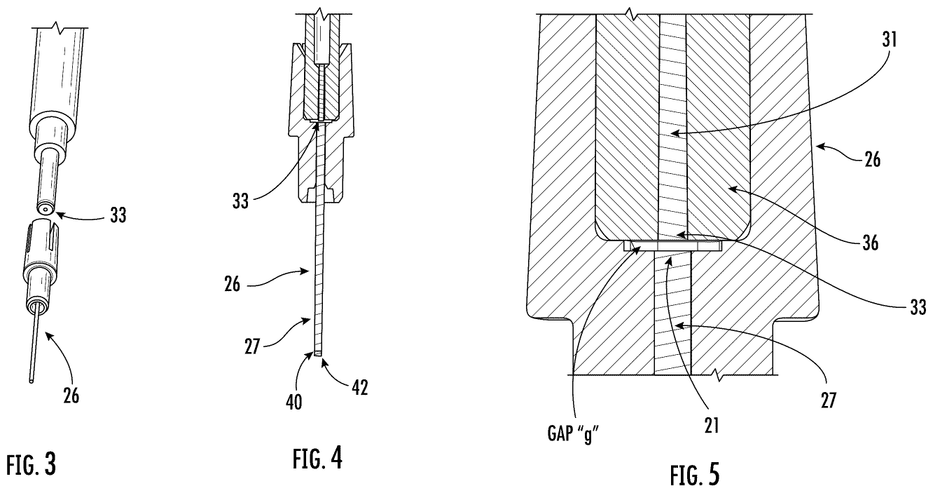

FIGS. 3-5, illustrate a portion of the apparatus 20 showing the interface between the fiber optic bundle 31 and the optical fiber 27 of the optical assembly or BLI sensor 26. As shown, the distal tip 33 of the fiber optic bundle 31 is aligned with a proximal end portion 21 of the optical fiber 27 when the BLI sensor 26 is attached to the optical coupler 36. The BLI sensor 26 may be fixedly attached to the optical coupler 36 to align and maintain a position of the proximal end portion 21 with respect to the tip 33. The BLI sensor 26 includes a hub that attaches the BLI sensor to the optical coupler 36 and that is fixed to the proximal end portion of the optical fiber 27.

The BLI sensor 26 includes the optical fiber 27 having a proximal end and a distal end. The proximal end and/or the distal end of the optical fiber 27 may be polished ends. The distal end of the BLI sensor 26 has an optical resonator having a first reflecting surface 40 and a second reflecting surface 42 distal of the first reflecting surface. The optical fiber 27 is transparent between the proximal end and distal end thereof. The optical resonator may be transparent between the first and second reflecting surfaces 40, 42. The distance between the first and second reflecting surfaces 40, 42 defines a thickness “d” of the optical resonator. The thickness “d” may be in a range of 50 nm to 5,000 nm, e.g., between 400 nm and 1,000 nm.

The second reflecting surface 42 is formed of a layer of analyte-binding molecules or materials which are effective to bind analyte molecules specifically and with high affinity. That is, the analyte and anti-analyte molecules or materials are opposite members of a binding pair which can include, without limitations, antigen-antibody pairs, complementary nucleic acids, and receptor-binding agent pairs.

The index of refraction of the optical resonator may be similar to that of the biolayer between the distal surface and the second reflecting surface 42 so that light reflected from the second reflecting surface 42 occurs predominantly from the interface between the biolayer and the fluid in which it is immersed, rather than from the interface between the optical fiber 27 and the analyte-binding molecules, e.g., the first reflecting surface 40. Similarly, as analyte molecules bind to distal end portion of the optical assembly 26, light reflected from the distal end portion of the assembly occurs predominantly from the layer formed by the analyte-binding molecules and bound analyte, rather than from the interface region. The signal-to-noise ratio may be increased by having the index of refraction of the optical resonator similar to the index of refraction of the biolayer.

The first reflecting surface 40 of the optical assembly 26 may be formed as a layer of transparent material having an index of refraction that is substantially different than that of the optical fiber 27, such that this layer functions to reflect a portion of the light directed onto the optical assembly 26.

The thickness of an analyte-binding layer disposed in the distal end portion of the optical element 26 may be designed to optimize the overall sensitivity based on specific hardware and optical components. Conventional immobilization chemistries are used in chemically, e.g., covalently, attaching a layer of analyte-binding molecules to the lower surface of the optical element. For example, a variety of bifunctional reagents containing a siloxane group for chemical attachment to SiO2, and a hydroxyl, amine, carboxyl or other reaction group for attachment of biological molecules, such as proteins (e.g., antigens, antibodies), or nucleic acids may be used. It is also well known to etch or otherwise treat glass or glass surfaces to increase the density of hydroxyl groups by which analyte-binding molecules can be bound. Where the optical resonator at the distal end of the optical fiber 27 is formed of a polymer, such as polystyrene, a variety of methods are available for exposing available chemically active surface groups, such as amine, hydroxyl, and carboxyl groups.

The analyte-binding layer is preferably formed under conditions in which a distal end surface of the optical fiber 27 is densely coated, so that binding of analyte molecules to the layer forces a change in the thickness of the layer, rather than filling in the layer. The analyte-binding layer can be either a monolayer or a multi-layer matrix.

The measurement of the presence, concentration, and/or binding rate of analyte to the optical assembly is enabled by the interference of reflected light beams from the two reflecting surfaces in the optical assembly. Specifically, as analyte molecules attach to or detach from the surface, the average thickness of the biolayer changes accordingly. Because the thickness of all other layers remains the same, the interference wave formed by the light waves reflected from the two surfaces is phase shifted in accordance with this thickness change.

Assuming that there are two reflected beams: The first beam is reflected from the first reflecting surface 40 and the second beam is reflected from the analyte-binding molecules and bound analyte and the surrounding medium at the second reflecting surface 42. The conversion of the phase shifting to a thickness change of the bound analytes is well known in the art as discussed in at least U.S. Pat. No. 8,305,585 and will not be discussed further for reasons of brevity.

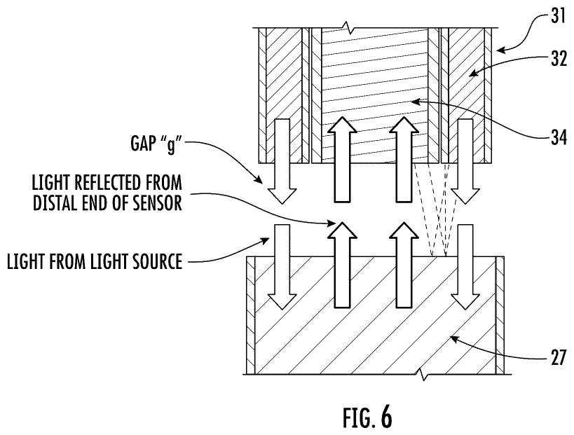

Referring to FIG. 6, when the fiber optic bundle 31 is fixed relative to the optical fiber 27 as discussed above, a gap “g” is formed between the fiber optic bundle 31 and a proximal end of the optical fiber 27. The size of the gap “g” may reduce optical cross talk between the light source 22 and the detector 28. For example, light delivered from the first optical waveguide 32 may reflect off of a proximal end of the optical fiber 27 and into the second optical waveguide 34 that delivers the reflected light to the detector 28. The reflected light may only be reflected when the angle of light from the first optical waveguide 32 hits the optical fiber 27 at an angle greater than the maximum acceptance angle of the optical fiber 27. It may be beneficial to reduce the amount of reflected light at the gap “g” to reduce background noise at the detector 28. The gap “g” may be in a range of 25 μm to 600 μm, e.g., 50 μm, 100 μm, 200 μm, 300 μm, 400 μm, or 500 μm. The gap “g” may be tuned based on materials used for the first optical waveguide 32, the second optical waveguide 34, and/or the optical fiber 27. Arranging the fibers of the first optical waveguide 32 about the fiber or fibers of the second optical waveguide 34 may reduce or minimize reflected light from the proximal end of the biosensor such that a signal to noise ratio (SNR) of the apparatus 20 is improved compared to other arrangements of fibers of the first optical waveguide 32 and fibers of the second optical waveguide 34.

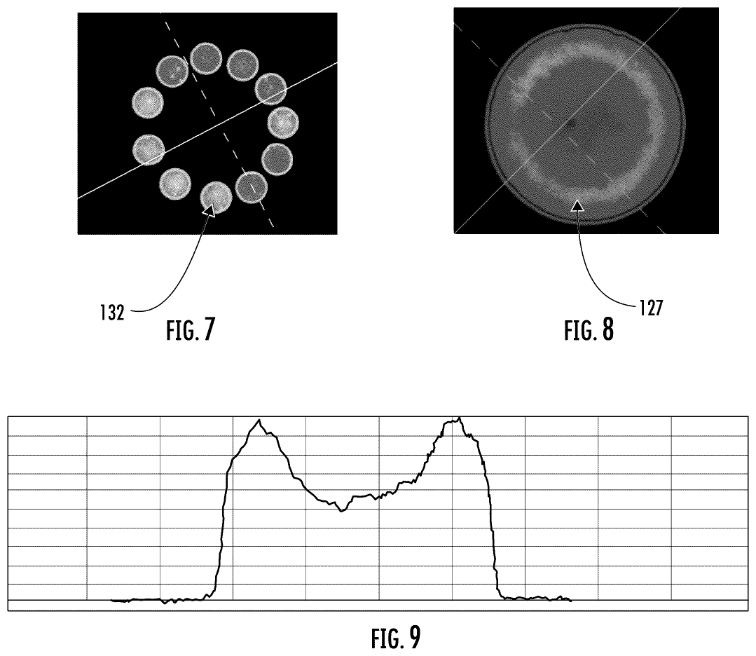

Referring now to FIGS. 7-9, a beam profile 132 of the first optical waveguide 32 and a beam profile 127 of the optical fiber 27 at the second reflecting surface 40 thereof are illustrated. It is noted that the optical fiber 27 has a circular profile. As shown, the beam profile 132 from the first optical waveguide 32 is provided as a ring of light with a circular profile provided from each of the optical fibers of the first optical waveguide 32 to substantially form a ring of light about the second optical waveguide 34 (not shown but positioned within the void of light within the beam profile 132). When the light from the first optical waveguide 32 is received and transmitted through the optical fiber 27 from the proximal end portion 21 to the distal end portion, the beam profile 132 is substantially the same as shown with beam profile 127 such that the profile of illumination is not substantially changed. That is, while the light tends to fill the spaces between the optical fibers to form a ring of light in the beam profile 127, there is little scattering of light from the beam to fill areas of the optical fiber 27 outside of the ring. Specifically, as shown by the beam profile 127, the center of the optical fiber 27 and the outer perimeter have a low intensity of light. The areas of low intensity of light may result in a low signal to noise ratio and/or allow for additional noise as the light is reflected back to the detector 28.

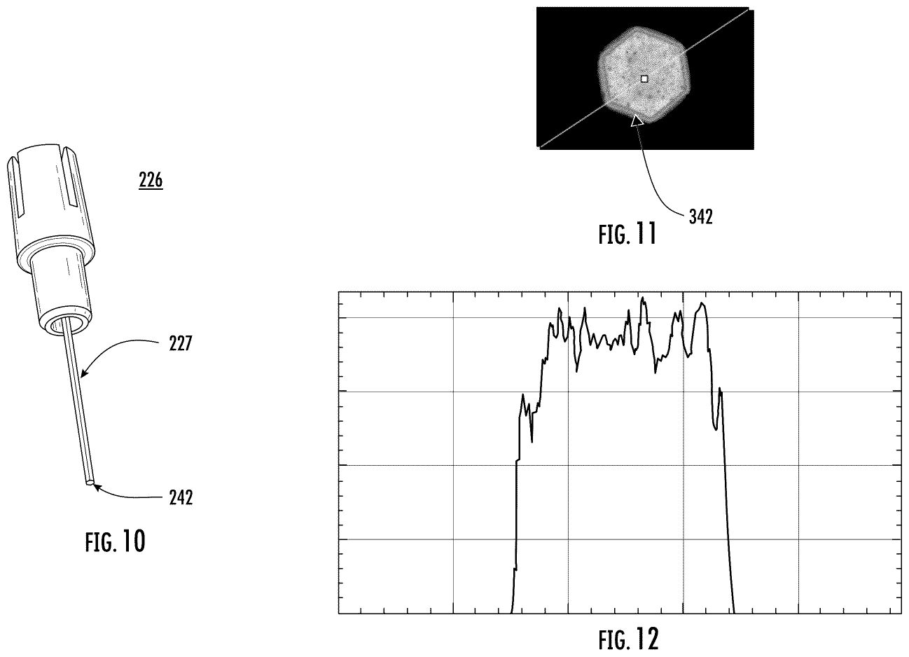

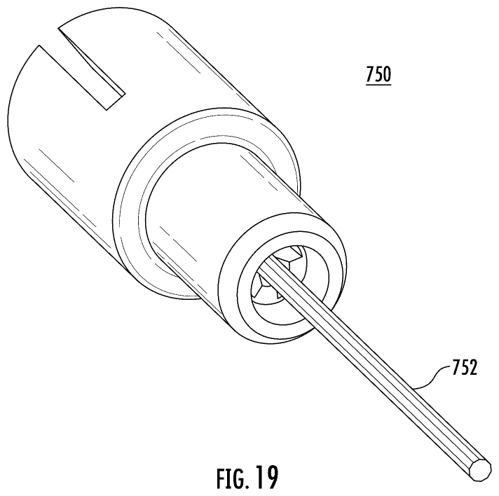

Referring now to FIG. 10, a BLI sensor 226 with a faceted optical fiber 227 is provided in accordance with an embodiment of the present disclosure. The BLI sensor 226 is similar to the BLI sensor 26 but with a faceted optical fiber 227 in place of a circular optical fiber 27. The faceted optical fiber 227 has a substantially constant cross-section along a length of the optical fiber 227, e.g., from the proximal end portion to the distal end portion thereof. The cross-section of the faceted optical fiber 227 may have a variety of shapes including, but not limited to, triangular (FIG. 15), square (FIG. 16), pentagonal (FIG. 17), hexagonal (FIG. 10), octagonal (FIG. 18), or decagonal (FIG. 19). The cost of a faceted optical fiber is substantially similar to a circular optical fiber such that this modification can be made with no or little additional cost. As used herein, the term “faceted optical fiber” refers to an optical fiber that has a polygonal cross-section. It will be appreciated that a circular optical fiber has a circular cross-section and thus, does not have a polygonal cross-section.

With additional reference to FIGS. 11 and 12, a beam profile 342 at the second reflecting surface 242 of the faceted optical fiber 227 is illustrated in accordance with embodiments of the present disclosure after receiving light from the first optical waveguide 32 of the fiber optic bundle 31 (FIG. 2). As shown, the beam profile 342 at the second reflecting surface 242 is uniform in distribution. The facets of the faceted optical fiber 227 may scramble light within the faceted optical fiber 227 to distribute the light more evenly as compared to the round or circular optical fiber 27. This uniform distribution of light at the second reflecting surface 242 may increase a single to noise ratio (SNR) of the BLI sensor 226 with a faceted optical fiber 227 as compared to a BLI sensor with a circular or non-faceted optical fiber. The increased SNR may increase the sensitivity of the BLI sensor 226 with the faceted optical fiber 227 as compared to a BLI sensor with a circular or non-faceted optical fiber.

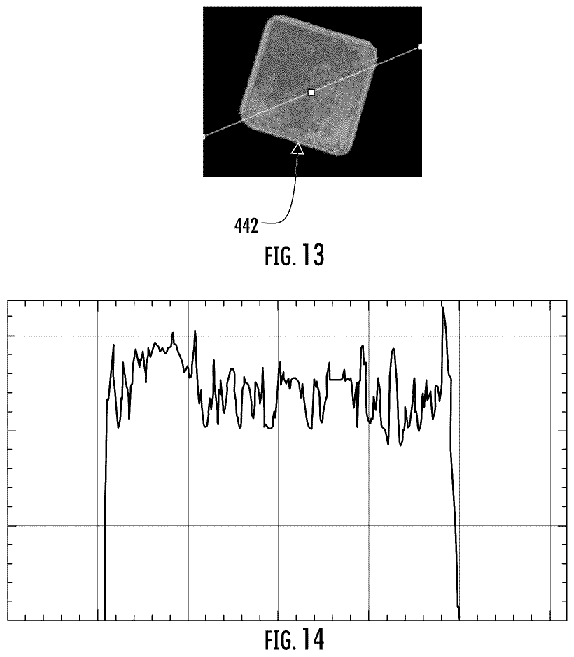

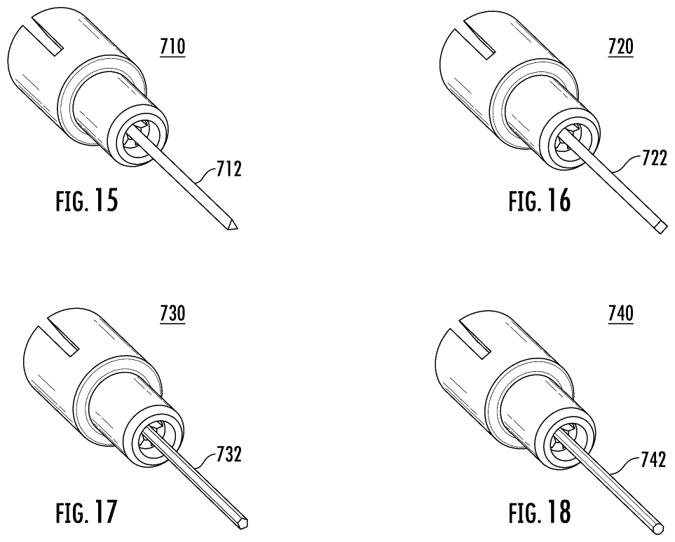

Referring now to FIGS. 13 and 14, a beam profile 442 at the second reflecting surface of a faceted optical fiber with a square cross-section is illustrated in accordance with embodiments of the present disclosure. As shown, the beam profile 442 shows a uniform distribution of light at the second reflecting surface thereof similar to the beam profile 342 of the faceted optical fiber 227. This uniform distribution of light at the second reflecting surface for the square cross-section faceted optical fiber may increase a single to noise ratio (SNR) of a BLI sensor as compared to a BLI sensor 20 with a circular or non-faceted optical fiber 27. The increased SNR may increase the sensitivity of a BLI sensor with the faceted optical fiber as compared to a BLI sensor with a circular or non-faceted optical fiber.

With reference to FIGS. 15-19, BLI sensors with faceted optical fibers are shown in accordance with embodiments of the present disclosure. Specifically, FIG. 15 illustrates a BLI sensor 710 including a faceted optical fiber 712 with a triangular cross-section, FIG. 16 illustrates a BLI sensor 720 having a faceted optical fiber 722 with a square cross-section, FIG. 17 illustrates a BLI sensor 730 having a faceted optical fiber 732 with a pentagonal cross-section, FIG. 18 illustrates a BLI sensor 740 having a faceted optical fiber 742 with an octagonal cross-section, and FIG. 19 illustrates a BLI sensor 750 having a faceted optical fiber 752 with a decagonal cross-section.

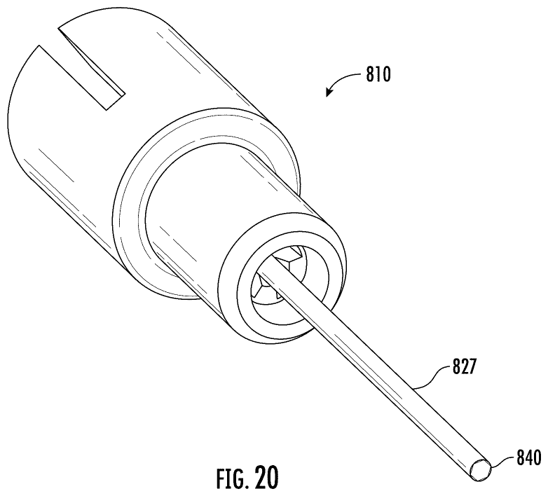

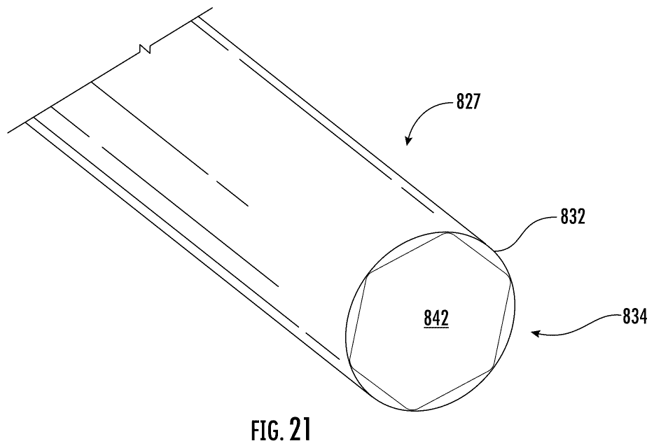

Referring now to FIGS. 20 and 21, another BLI sensor 810 is provided in accordance with the present disclosure. The BLI sensor 810 is similar to the BLI sensor 26 but with an internally faceted optical fiber 827 in place of a circular optical fiber 27. The internally faceted optical fiber 827 has a substantially constant cross-section along a length of the optical fiber 827, e.g., from the proximal end portion to the distal end portion thereof. The optical fiber 827 that has a circular or cylindrical external surface and an internal faceted cross-section. With particular reference to FIG. 21, the optical fiber 827 has an internal faceted core 842 and a cladding 832 that forms an external surface 834 having a circular cross-section. In certain embodiments, the external surface 834 has an oval cross-section. As shown, the internal faceted core 842 has a hexagonal cross-section; however, in some embodiments, the internal faceted core 842 may have a triangular, square, pentagonal, octagonal, decagonal, or other faceted cross-section. The cladding 832 is disposed about and secured to the internal faceted core 842. For example, the cladding 832 may be bonded or adhered to the core 842. In some embodiments, the cladding 832 is a monolith structure with a passage sized and dimensioned to receive the core 842 therein. In certain embodiments, the cladding 832 and the core 842 are formed from a single or double extrusion process with the cladding 832 extruded over the core 842.

The optical fiber 827 functions in a similar manner to the faceted optical fibers, e.g., optical fiber 227, 712, 722, 732, 742. For example, the optical fiber 827 receives a beam of light in the form of a ring of light from a first optical waveguide and scrambles the beam of light within the faceted core 842 such that at the tip of the optical fiber 827, the core 842 has a uniform distribution of light at the tip 840 of the optical fiber 827. In some embodiments, the core 842 has a uniform distribution of light and the cladding 832 has little to no light distributed therein at the tip 840 of the optical fiber 827.

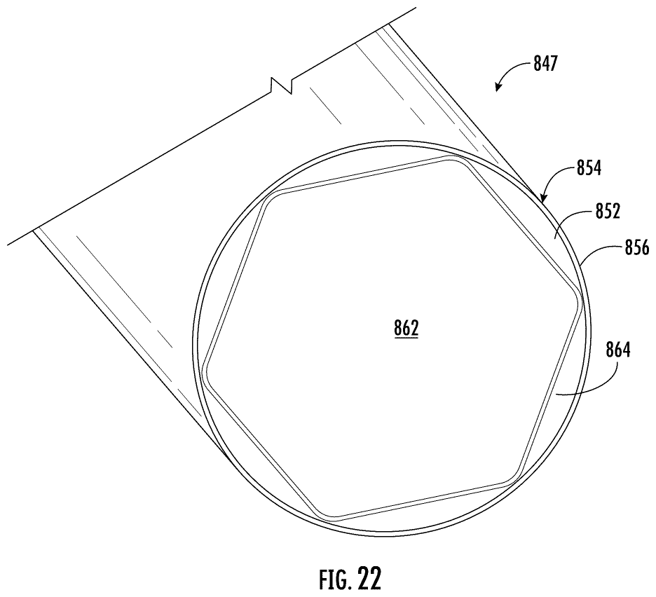

Referring now to FIG. 22, the tip of another internally faceted optical fiber 847 of a BLI sensor is provided in accordance with the present disclosure. The internally faceted optical fiber 847 may be used in place of the optical fibers of BLI sensors detailed herein. The internally faceted optical fiber 847 has a substantially constant cross-section along a length of the optical fiber 847, e.g., from the proximal end portion to the distal end portion thereof. The optical fiber 847 has a circular or cylindrical external surface and an internal faceted cross-section. The optical fiber 847 has an internal faceted core 862, a first cladding 864, and a second cladding 852. The internal faceted core 862 may have a hexagonal cross-section as shown or may have a triangular, square, pentagonal, octagonal, decagonal, or other faceted cross-section. The first cladding 864 is disposed about the internal faceted core 862. The first cladding 864 may be a thin coating that in combination with the material of the internal faceted core 862 provides a desired numerical aperture (NA). The first cladding 864 may be formed from a glass material, a quartz material, or other similar material. The second cladding 852 forms the shape of an external surface 854 of the optical fiber 847. The shape of the external surface 854 may have a circular or oval cross-section. The second cladding 852 is disposed about and secured to the first cladding 864. For example, the second cladding 852 may be bonded or adhered to the first cladding 864. In some embodiments, the second cladding 852 is a monolith structure with a passage sized and dimensioned to receive the internal faceted core 862 and the first cladding 864 therein. The second cladding 852 may be formed from the same or different material as the first cladding 864. The second cladding 852 may provide additional support and/or protection for the first cladding 864. The second cladding 852 may be coated with a protective coating 856 that forms the external surface 854 of the optical fiber 847. In some embodiments, the protective coating has a thickness in a range of 5-10 μm. In some embodiments, the protective coating 856 is formed of polyamide, polytetrafluoroethylene (PTFE), or similar material. In some embodiments, the optical fiber 847 is provided without the second cladding 852 and/or the protective coating 856.

The overall diameter of the optical fiber 847 may be in a range of 720-730 μm. In certain embodiments, the optical fiber 847 may have a diameter of less than 720 μm or greater than 730 μm. For example, the optical fiber 847 may have a diameter in a range of 1000 μm to 1200 μm, e.g., 1190 μm. The overall diameter of the optical fiber 847 may be sized to assemble with a hub to form a BLI sensor. The size of the internal faceted core 862 may be maximized relative to the overall diameter of the optical fiber 847. In certain embodiments, the internal faceted core 862, the first cladding 864, and the second cladding 852 are formed from a single, double, or triple extrusion process with the first cladding 864 extruded over the core 862 and the second cladding 852 extruded over the first cladding 864.

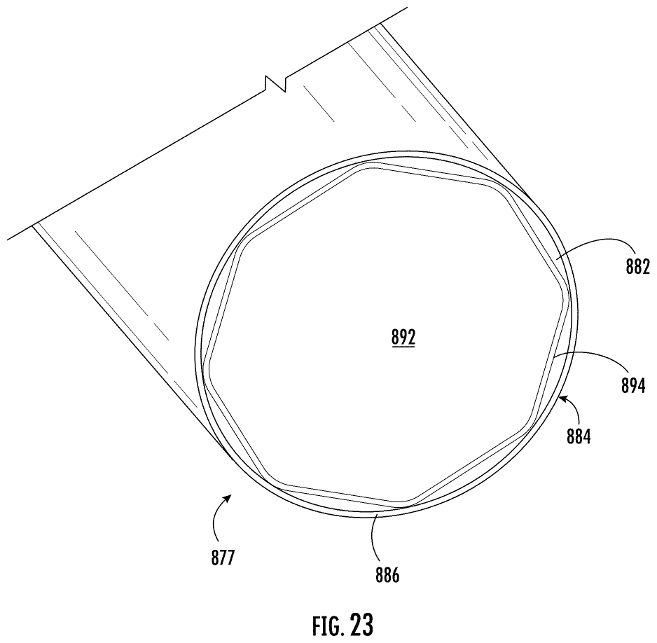

Referring now to FIG. 23, the tip of another internally faceted optical fiber 877 of a BLI sensor is provided in accordance with the present disclosure. The internally faceted optical fiber 877 may be used in place of the optical fibers of BLI sensors detailed herein. The internally faceted optical fiber 877 has a substantially constant cross-section along a length of the optical fiber 877, e.g., from the proximal end portion to the distal end portion thereof. The optical fiber 877 has an ovular external surface and an internal faceted cross-section. The optical fiber 877 has an internal faceted core 892, a first cladding 894, and a second cladding 882. The internal faceted core 892 has an octagonal cross-section. The first cladding 894 is disposed about the internal faceted core 892. The first cladding 894 may be a thin coating that in combination with the material of the internal faceted core 892 provides a desired numerical aperture (NA). The first cladding 894 may be formed from a glass material, a quartz material, or other similar material. The second cladding 882 forms the shape of an external surface 884 of the optical fiber 877. The shape of the external surface 884 may have a circular or oval cross-section. The second cladding 882 is disposed about and secured to the first cladding 894. For example, the second cladding 882 may be bonded or adhered to the first cladding 894. In some embodiments, the second cladding 882 is a monolith structure with a passage sized and dimensioned to receive the internal faceted core 892 and the first cladding 894 therein. The second cladding 882 may be formed form the same or different material as the first cladding 894. The second cladding 882 may provide additional support and/or protection for the first cladding 894. The second cladding 882 may be coated with a protective coating 886 that forms the external surface 884 of the optical fiber 877. In some embodiments, the protective coating has a thickness in a range of 5-10 μm. In some embodiments, the protective coating 886 is formed of polyamide, polytetrafluoroethylene (PTFE), or similar material. In some embodiments, the optical fiber 877 is provided without the second cladding 882 and/or the protective coating 886.

The overall diameter of the optical fiber 877 may be in a range of 720-730 μm. In certain embodiments, the optical fiber 877 may have a diameter of less than 720 μm or greater than 730 μm. For example, the optical fiber 877 may have a diameter in a range of 1000 μm to 1200 μm, e.g., 1190 μm. The overall diameter of the optical fiber 877 may be sized to assemble with a hub to form a BLI sensor. The size of the internal faceted core 892 may be maximized relative to the overall diameter of the optical fiber 847. In certain embodiments, the internal faceted core 862, the first cladding 894, and the second cladding 882 are formed from a single, double, or triple extrusion process with the first cladding 894 extruded over the core 892 and the second cladding 882 extruded over the first cladding 894.

While several embodiments of the disclosure have been shown in the drawings, it is not intended that the disclosure be limited thereto, as it is intended that the disclosure be as broad in scope as the art will allow and that the specification be read likewise. Any combination of the above embodiments is also envisioned and is within the scope of the appended claims. Therefore, the above description should not be construed as limiting, but merely as exemplifications of particular embodiments. Those skilled in the art will envision other modifications within the scope of the claims appended hereto.

What is claimed:

1. A biosensor comprising:
an optical fiber having a proximal end portion and a distal end portion, the proximal end portion configured to receive light from a light source and configured to deliver reflected light to a detector, the optical fiber having a polygonal cross-section; and
an optical resonator at the distal end portion of the optical fiber, the optical resonator having a first reflecting surface and a second reflecting surface, the second reflecting surface configured to have analytes bind thereto, the first reflecting surface configured to reflect light with a first phase and the second reflecting surface configured to reflect light with a second phase which is phase shifted based on a thickness of analytes bound to thereto.

2. The biosensor according to claim 1, wherein the optical fiber has a triangular, square, pentagonal, hexagonal, octagonal, or decagonal cross-section.

3. The biosensor according to claim 1, wherein the optical fiber is configured to scatter light to evenly distribute light in the distal end portion of the optical fiber.

4. The biosensor according to claim 1, wherein the optical fiber is configured to receive a beam of light in the proximal end portion and uniformly distribute light from the received beam of light at the distal end portion thereof.

5. The biosensor according to claim 1, wherein the optical resonator is formed of polystyrene.

6. An interferometer apparatus comprising:
a first optical waveguide configured to receive light from a light source;
a second optical waveguide configured to deliver reflected light to a detector;
an optical coupler spatially separating a distal portion of the first optical waveguide from a distal portion of the second optical waveguide; and
a biosensor attached to the optical coupler, the biosensor comprising an optical fiber according to claim 1.

7. A biosensor comprising:
an optical fiber having a proximal end portion and a distal end portion, the proximal end portion configured to receive light from a light source and configured to deliver reflected light to a detector, the distal end portion configured to have analytes bind thereto such that light reflected from the distal end portion is phase shifted based on a thickness of analytes bound to the distal end portion, the optical fiber having a faceted core disposed within a first cladding, the faceted core having a core cross-section, the core cross-section being polygonal.

8. The biosensor according to claim 7, further comprising an optical resonator at the distal end portion of the optical fiber, the optical resonator including a first reflecting surface and a second reflecting surface, the first reflecting surface configured to reflect light with a first phase and the second reflecting surface configured to reflect light with a second phase which is phase shifted based on a thickness of analytes bound to the optical resonator.

9. The biosensor according to claim 7, wherein the first cladding defining an exterior cross-section of the optical fiber, the exterior cross-section being circular or ovular.

10. The biosensor according to claim 7, wherein the core cross-section is triangular, square, pentagonal, hexagonal, octagonal, or decagonal.

11. The biosensor according to claim 7, wherein the optical fiber includes a second cladding disposed about the first cladding, the second cladding defining an exterior cross-section of a different shape than a shape of the core cross-section.

12. The biosensor according to claim 11, wherein the exterior cross-section is circular or ovular.

13. The biosensor according to claim 11, wherein the optical fiber includes a coating over the second cladding, the coating defining an exterior surface of the optical fiber.

14. The biosensor according to claim 13, wherein the first cladding is formed of glass or quartz, the second cladding is formed of glass or quartz, and the coating is formed of polyamide or polytetrafluoroethylene.

15. The biosensor according to claim 11, wherein the first cladding and the second cladding are formed of the same material.

16. The biosensor according to claim 7, wherein the faceted core and the first cladding in combination with one another provide a desired numerical aperture of the optical fiber.

17. An interferometer apparatus comprising:
a first optical waveguide configured to receive light from a light source;
a second optical waveguide configured to deliver reflected light to a detector;
an optical coupler spatially separating a distal portion of the first optical waveguide from a distal portion of the second optical waveguide; and
a biosensor attached to the optical coupler, the biosensor comprising an optical fiber according to claim 7.

18. An interferometer apparatus comprising:
a light source emitting light;
a first optical waveguide receiving light from the light source;
a detector;
a second optical waveguide delivering reflected light to the detector;
an optical coupler spatially separating a distal portion of the first optical waveguide from a distal portion of the second optical waveguide; and
a biosensor attached to the optical coupler, the biosensor comprising:
an optical fiber having a proximal end portion and a distal end portion, the proximal end portion receiving light from the first optical waveguide and delivering reflected light to the second optical waveguide, the optical fiber having a polygonal cross-section; and
an optical resonator at the distal end portion of the optical fiber, the optical resonator having a first reflecting surface and a second reflecting surface, the second reflecting surface configured to have analytes bind thereto, the first reflecting surface configured to reflect light with a first phase and the second reflecting surface configured to reflect light with a second phase which is phase shifted based on a thickness of analytes bound to thereto.

19. The interferometer apparatus according to claim 18, wherein optical resonator is transparent between the first reflecting surface and the second reflecting surface.

20. The interferometer apparatus according to claim 18, wherein the first reflecting surface has a first index of refraction that is different from a fiber index of refraction of the optical fiber.
